(19) United States
(12) Patent Application Publication
(10) Pub. No.: US 2019/0213611 A1
(43) Pub. Date: Jul. 11, 2019

(54) SYSTEM FOR ONLINE POLLING

(71) Applicants: Ryan Duhigg, Ronkonkoma, NY (US); Jason Falquecee, Commack, NY (US)

(72) Inventors: Ryan Duhigg, Ronkonkoma, NY (US); Jason Falquecee, Commack, NY (US)

(21) Appl. No.: 15/864,143

(22) Filed: Jan. 8, 2018

(51) Int. Cl. G06Q 30/02; G06F 17/30

(52) U.S. Cl. CPC G06Q 30/0203; G06F 17/30867; G06Q 50/01; G06F 17/3053; G06Q 30/0201; G06F 17/30554

(57) ABSTRACT

A system for online polling comprises a polling server interactively connectable with a user over the internet and capable of conducting an online poll by presenting to the user a question and selectable answers, wherein in response to an answer being selected, the user is directed to a results page whereby the user can view the resulting poll data. In one version, the polling server also allows the user to create a poll by receiving a question from the user, searching the polling server for an existing poll with a similar question, and creating a new poll if no similar poll exists. The user may also be allowed to debate the topic and/or interact with the poll data.

### FIELD

The embodiments provided related to a polling system, and in particular, to an online polling system.

### BACKGROUND

For as long as there have been reasoning minds, humans have felt an innate need to share opinions. From the ancient days of opinions on the best predator-avoiding techniques to current opinions on celebrity fashion trends, the sharing of opinions helps societies survive, prosper, and operate efficiently. In the modern world with the advent of the internet and social media, never has there been more sharing of opinions.

Fully understanding public opinion is an important endeavor. The knowledge and tracking of public opinion is important across almost every industry. Marketers need to have a finger on the public's pulse in order to effectively and efficiently market and design products. Politicians need to understand likely voting trends across regions and/or demographics in order to be able to best allocate campaign resources and test campaign strategies. Sports fans find it fun and interesting to track public opinion on their favorite teams or on who most people think will win an event. And everyone enjoys being informed about opinions concerning the best places to eat, travel, shop, or otherwise do business.

However, quantifying opinions has proven to be a difficult task. Heretofore there has not been a polling site accessible by the public that focuses on polls of all types and that provides clear, accurate, analyzable, and interactive poll data. Old methods of polling are typically created in isolated situations and lead to inaccurate results. These polls are easily manipulated, lack transparency, and do not allow for interactive debate.

Therefore, there is a need for a centralized platform for users to create and contribute to polls. There is further a need for polls to be unique and accurate to the highest degree in accordance with the world population. There is a need to provide a platform for users to interact and debate on any topics that they choose.

### SUMMARY

The present invention satisfies these needs. In one aspect of the invention, a system is provided where accurate polls can be created, viewed, analyzed, customized, and/or interacted with in a convenient and entertaining environment.

In another aspect of the invention, a system for online polling comprises a polling server interactively connectable with a user over the internet and capable of conducting an online poll by presenting to the user a question and selectable answers, wherein in response to an answer being selected, the user is directed to a results page whereby the user can view the resulting poll data. The polling server also allows the user to create a poll by receiving a question from the user, searching the polling server for an existing poll with a similar question, and creating a new poll if no similar poll exists.

In another aspect of the invention, a system for online polling comprises a polling server interactively connectable with a user over the internet and capable of conducting an online poll by presenting to the user a question and selectable answers, wherein in response to an answer being selected, the user is directed to a results page whereby the user can view the resulting poll data. The polling server also allows the user to enter a participant interaction section related to the poll where the user may post information concerning the poll and view information posted by other poll participants.

In another aspect of the invention, a system for online polling comprises a polling server interactively connectable with a user over the internet and capable of conducting an online poll by presenting to the user a question and selectable answers, wherein in response to an answer being selected, the user is directed to a results page whereby the user can interact with the resulting poll data. The polling server also associates the selected answer with the user's demographic information, and the user is able to interact with the resulting poll data by filtering the results of the poll by selecting one or more items of demographic information.

In another aspect of the invention, a method of conducting a plurality of online polls on a server comprises establishing an interactive connection with a user; allowing the user to access one of a plurality of polls stored on the server, each poll including a question and selectable answers; after the user has selected an answer, displaying to the user results of the poll including answers made by prior users; and allowing the user to create a new poll. The creation of the new poll is accomplished by receiving a question from the user, searching the plurality of polls for an existing poll with a similar question, and creating a new poll if no similar poll exists.

In another aspect of the invention, a method of conducting a plurality of online polls on a server comprises establishing an interactive connection with a user; allowing the user to access one of a plurality of polls stored on the server, each poll including a question and selectable answers; allowing the user to enter a participant interaction section related to the poll; and allowing the user to post information concerning the poll and view information posted by other poll participants.

In another aspect of the invention, a method of conducting an online poll on a server comprises establishing an interactive connection with a user; allowing the user to access one of a plurality of polls stored on the server, each poll including a question and selectable answers; storing the selected answers to the poll made by prior participants and associating the stored answers with demographic information related to the prior participants; after the user has selected an answer, displaying the results of the poll to the user; allowing the user to interact with the results of the poll by filtering the results according to one or more items of demographic information.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic diagram of a system for online polling according to one version of the invention;

FIG. 2 is a flow chart illustrating a poll creation mode of operation of the system of FIG. 1;

FIG. 3 is a flow chart illustrating a poll analysis mode of operation of the system of FIG. 1;

FIG. 4 is a flow chart illustrating a poll customization mode of operation of the system of FIG. 1;

FIG. 5 is a flow chart illustrating a participant interaction mode of operation of the system of FIG. 1; and

FIG. 6 is a schematic diagram of a sample user interface for the system of FIG. 1.

### DETAILED DESCRIPTION

The present invention relates to a system for online polling. In particular, the invention relates to an app or internet website for collection of information about public opinion. Although the invention is illustrated and described in the context of being useful for collecting and analyzing poll data, the present invention can be used in other ways, as would be readily apparent to those of ordinary skill in the art. Accordingly, the present invention should not be limited just to the examples and embodiments described herein.

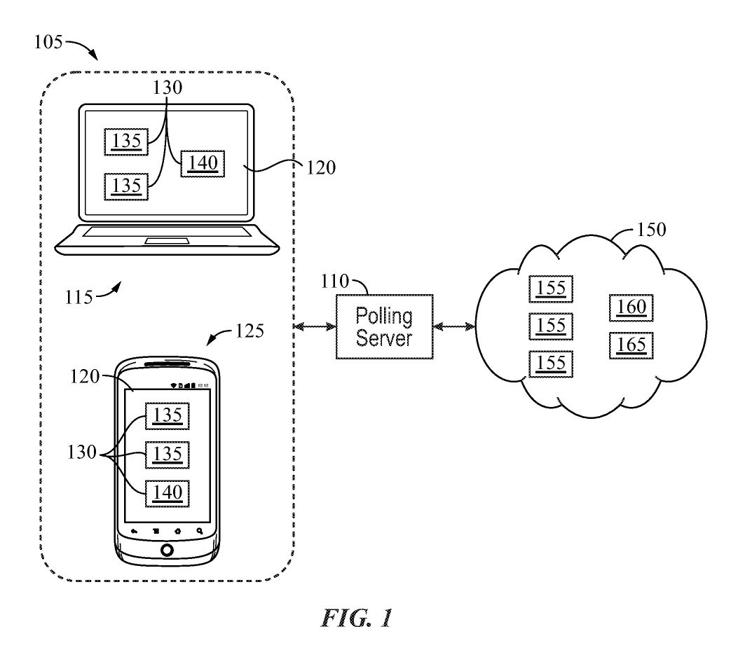

A system 100 for conducting one or more online polls is shown in FIG. 1. A user 105 creates an account and logs on to a polling server 110. The polling server 110 may be any device, network, or system that can communicate with the user 105 in accordance with one or more features of the present invention. For example, the polling server 110 may be in the form of one or more servers and/or a cloud network made up of one or more servers. The user 105 may be an individual or any program that allows the individual to interact with information on the internet, such as a traditional web browser available on most computers and hand-held devices. In one version, the user 105 is an internet browser housed within a computer 115 that displays information to an individual on a display screen 120, such as a screen on a computer, television, or hand-held device. The user 105 can be directed to the polling server 110 by an IP address and can interact with the polling server 110. Additionally, or alternatively, the user 105 may be a downloadable application (or app) on a handheld device 125, such as a smart phone or tablet device which also includes a display 120, through which an individual can interact over the internet with the polling server 110. The displayed image 135 may contain one or more blocks 130 of content. In the example shown in FIG. 1, the blocks 130 of content include one or more poll-related blocks 130 that visually display internet content created by or distributed by the polling server 110. The blocks of content 130 may also optionally contain additional blocks, such as one or more advertising blocks 140 that display advertising-related content, such as an advertisement, created by or delivered to the user 105 by an advertising network and/or by the polling server 110.

As also shown in FIG. 1, the polling server 110 also interacts with a larger network 150. The network 150 may, for example, be the internet or world wide web and is made of millions of entities, including other users 155, advertising networks 160, and search engines 165, just to mention of few. As will be described in more detail, the polling server 110 includes software and routines that allow it to interact with users 105, 155 and other entities and conduct one or more online polls. More specifically, the polling server 110 allows the creation, analysis, and/or customization of online polls by users 105, 155 and allow a user 105 to interact with an online poll, interact with data related to the online poll, and/or interact with one or more other users 155 with regards to the online poll. The polling server 110 provides its users with several advantageous features and options never before offered by a polling system.

The user 105 houses and executes poll interaction software that allows an individual to interact with the polling server 110. The poll interaction software may be a downloadable program or application that is downloaded onto the computer 115 or handheld device 125. The downloadable program or application allows for the individual to enter data and for the data to be delivered to the polling server 110. The downloadable program or application is also able to receive data from the polling server 110 and to display that data to an individual. In another version, the user 105 interacts with a web browser housed on the computer 115 or handheld device 125. The web browser connects with the polling server 110 and allows for the mutual exchange of data between the user 105 and the polling server 110. Any other form of transferring data between the user 105 and the polling server 110 may alternatively be employed. With any of the systems, the user 105 is able to connect to and interact with the polling server 110 so that the user 105 can create, analyze, and/or customize an online poll and so that the user 105 can interact with an online poll, interact with data related to an online poll, and/or interact with one or more other users with regard to an online poll. The user 105 and the polling server 110 can interact with one another in or more of several different modes, including a poll creation mode, a poll analysis mode, a poll customization mode, and a participant interaction mode.

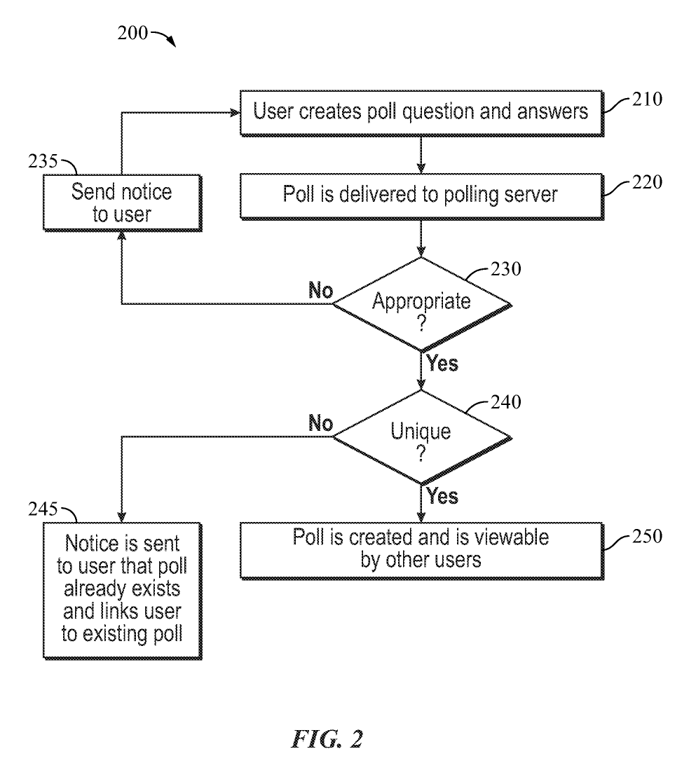

FIG. 2 illustrates a poll creation mode 200 of operation according to one version of the invention. First, an individual enters 210 data describing a desired poll into the poll interaction software on the user 105. The poll can be any question that the individual desires to pose to other users 155 interacting with the polling server 110. For example, the poll may pose a question about a political race, a political issue, sports, entertainment, beauty, fashion, food, wine, beer, philosophy, religion, and the like. Typically, the poll will include a question and then two or more selectable answers to the question. For example, a created poll may include the question, “Which team will win the Super Bowl?” The poll will then offer selectable options, such as “Team X” and “Team Y.” Additionally, or alternatively, the poll may offer a participant the ability to enter a write-in answer. By “question” it is meant any topic for which there are selectable responses. The “question” may sometimes not be in the form of an actual question. For example, the above poll may be phrased such as “The team that will win the Super Bowl is:”

As also shown in FIG. 2, the user data is then delivered 220 to the polling server 110 where it is optionally evaluated 230 for appropriateness. For example, the polling server 110 may check the data for certain words, phrases or subject matter that are deemed to be inappropriate for publication. If not appropriate, the polling server 235 sends a notice explaining the issue to the user 105 and then allows the user 105 to correct the problem. If the poll is determined to be appropriate, the polling server 110 then evaluates 240 the poll for uniqueness. If the poll is determined to already exist, notice is sent 245 to the user 105 to inform the user 105 that the poll already exists and directs the user 105 to the existing poll and/or provides the user 105 with a link to the existing poll. If the poll is determined to be unique, a new poll is created and is viewable by both the user 105 and by other users 155. Once the user 105 creates a poll or is directed to a previously created poll, the user 105 can answer the poll question and/or can share to poll with the user's friends or selected friends.

Sometimes a new poll with be close but not identical to an existing poll. In one version, the polling server 110 can analyze the difference to determine if the new poll is sufficiently unique to warrant being posted as a new poll. If the polls differ only in phraseology of the question and/or possible answers, no new poll will be created. If the difference is more substantial, the creator of the new poll may be asked if he or she would like to utilize the existing poll instead of the new poll. Alternatively, the polls may be merged and combined into a single poll.

When a poll is created, a user can view the poll and interact with the poll by choosing an answer. When an answer is selected, the poll results will be presented to the user. By assuring that each poll is unique, more accurate information can be obtained. By consolidating all similar polls, more data is generated, and more accurate results can be obtained. In contrast, if multiple similar polls existed, the results of each of the polls would be based on fewer participants. The smaller sample size polls would not depict the global picture and could be more easily manipulated. A compilation of all of the similar polls would be burdensome and time consuming. In addition, an individual using the poll can become frustrated when there are multiple similar polls that turn up during a search. With a single, unique poll presented by the present system 100, the results are thus more representative of the population as a whole and are less likely to be manipulated by a small portion of the population.

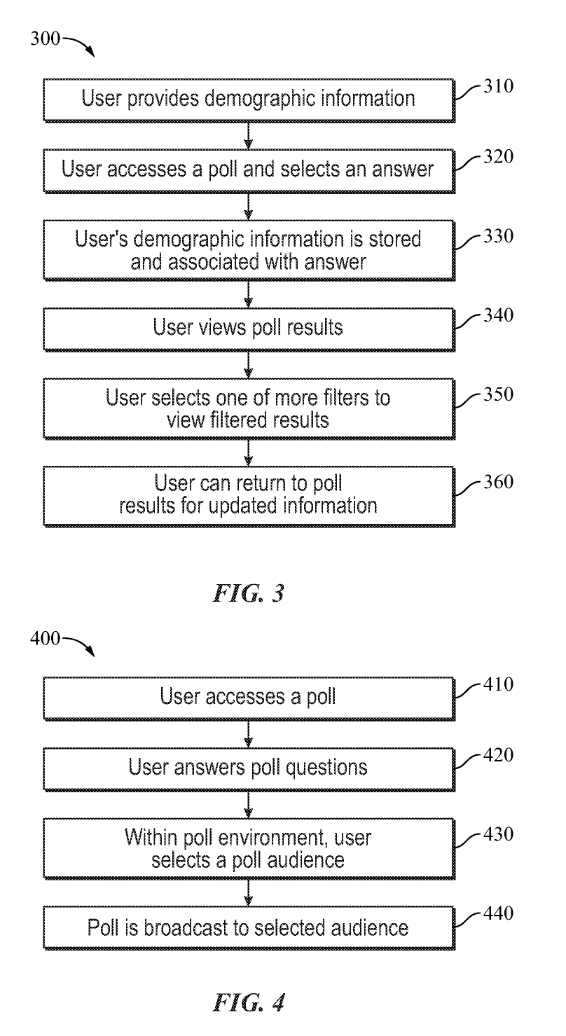

FIG. 3 illustrates the use of the system 100 in a poll analysis mode 300. Since the poll is a single, unique poll, it contains global data from all participants in the poll. However, by using selectable filters, more detailed information about the information concerning the poll can be researched and analyzed. For each participant in the poll, demographic information is obtained 310 and stored. In one version, the user 105 enters his or her demographic information at the time of creating an account. The demographic information is associated with the user 105 so that each time the user 105 logs in the polling server 110 can retrieve the demographic information. In another version, the user 105 can enter his or her demographic information when the user 105 participates with a poll. The user 105 accesses 320 a poll such as by searching for the poll or otherwise being directed to it and selects an answer to the poll question. The selected answer is tallied, and the answer as associated 330 with the user's demographic information. The user 105 is then directed 340 to a page where the user 105 can view the poll results. The user 105 can select 350 one or more filters to view the result of the poll as it pertains to certain demographics. For example, in one version, the filters can include one or more of age, sex, gender, sexual orientation, income, race, ethnicity, marital status, dependents, residency, geographical location, and the like. In this manner, the user 105 can analyze the results of the poll in more detail. For example, the results of the hypothetical poll may show that 55% of the population believes Team X will win the Super Bowl, but 60% of men favor Team X. The user 105 can later return 360 to the poll results, such as by bookmarking the poll or performing another search, to see updated poll results. The polling server 110 recognizes that the user has already participated in the poll and delivers the user immediately to the results page for the poll.

A poll may also be customizable by a user 105, and FIG. 4 illustrates a poll customization mode 400 of the system 100. First a user 105 accesses 410 a poll either by creating one, searching for one or otherwise being linked to a poll page. The user 105 answers 420 the poll question if the user has not previously done so to access the poll environment. The user 105 may then customize the poll, such as by selecting 430 a poll audience. The poll audience can be any subset of individuals. For example, the audience may be private, public, global, regional (for example a municipality, town, state, region, country or countries), a demographic group, all friends, a specific set of friends. The poll is then broadcast to the selected audience. The user 105 receives a notification when a member of the audience has answered the poll question. The user 105 also has the option of opting out of the notifications.

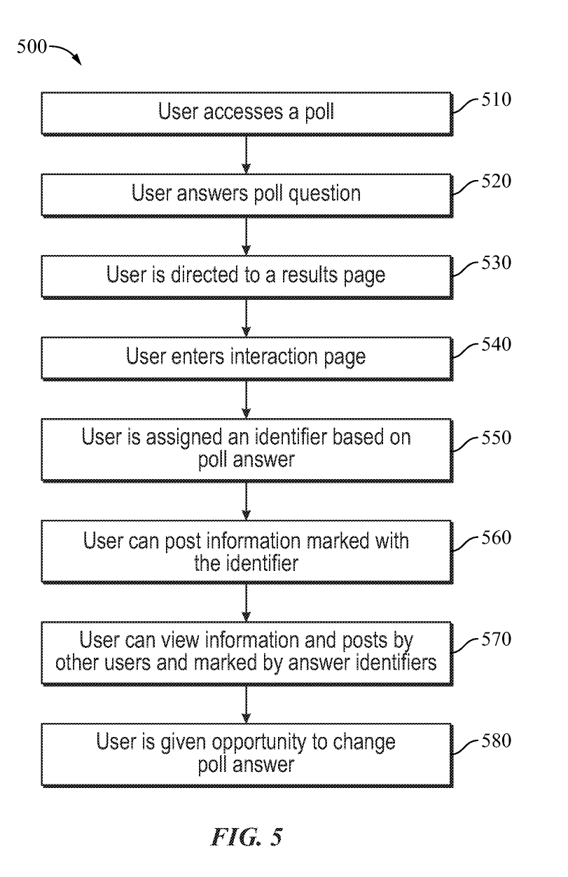

FIG. 5 shows a participant interaction mode 500 according to one version of the present invention. One of the advantageous features of the system 100 is the ability of a user 105 to interact with other users 155 who have participated in a poll. After a user 105 accesses 510 a particular poll and answers 520 the poll question or revisits a previously answered poll, the user 105 is directed 530 to a poll results page. From the poll results page or alternatively from the poll question page the user 105 can choose to enter 540 an interaction page where various information and communications concerning the poll can be viewed. For example, within the interactive page, the user may be able to read leading opinions associated with any possible answer to the poll question. There may also be a debate section (or “battleground”) where the user can leave his or her opinion on the poll question and/or can debate the issue with other participants who have answered the poll question and entered the interactive page. In one version, each answer to a particular poll question is assigned with an identifier. For example, the identifier may be a font color, font size, font style, a symbol. When the user 105 selects an answer to the poll question, the identifier is assigned 550 to the user 105. Then whenever the user 105 makes a post or leaves a comment, the post is marked with the identifier. All comments and posts from other users are marked with the same or a similar identifier. Thus, when the user 105 is viewing 570 posts and comments posted by other users 155, the user 105 can easily identify that the post was left by someone with the same or differing answer to the poll question as the user 105. A user 105 can write in an unlimited capacity and can tag other users in their comments to further strengthen their arguing points.

Within the debate section, a user 105 can search and organize the viewed information as desired. In one version, the comments will be listed in chronological order as they are contributed by the user 105 and/or other users 155. Alternatively, the comments can be ordered differently, as desired by the user 105. For example, there may be a ranking system whereby users can rank the effectiveness and/or relevance of a post, and the posts may be displayed in order of that ranking. Once inside the debate section, a user 105 can elect 580 to leave and change his or her answer to the poll question if they so choose.

The online polling system 100 of the invention may include additional features and options. In one version, a user 105 may select an interest filter from an option menu. With the interest filter, the user 105 may select one or more areas that are of interest to the user 105. For example, selectable interests may include one or more topics such as sports, politics, food, cars, animals, and the like. After making the interests selection, the user 105 will be exposed to appropriate polls in their feed.

In another version, the online polling system 100 includes a poll ranking system. The poll ranking system can be based on any of a number of criteria. For example, the poll ranking system may factor one or more of poll visits, number of poll answers, response time per answer selection, number of shares, number of likes. Additionally, or alternatively, each poll may be numerically rated by the participants, such as by allowing a user to select from one to five stars, based on the user's opinion of the poll. The higher ranked polls can then be presented to a user on the user's feed or can be ordered by ranking when a user 105 performs a search for a poll and/or applies interest filters. The highest ranked polls can be considered to be trending and can be displayed as such on a user's feed or when requested by the user 105.

In another version of the online polling system 100, one or more awards may be given to qualifying polls. The awards may be serious or mock. The awards may be viewable on the site or may be presented in a ceremony. The awards may also be a searchable or filter category.

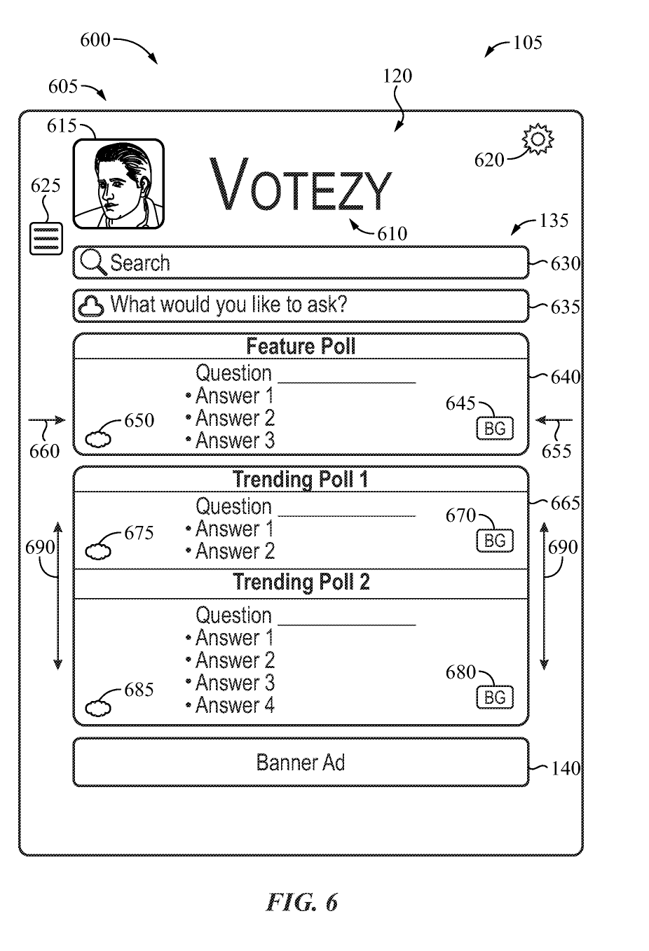

A sample user interface 600 is shown in FIG. 6. The user interface 600 is provided on a display screen 120 on the user 105. The screen may be a touch-screen type of device typically provided on a smart phone, tablet, or computer, or it may be a display screen that an individual can interact with using a cursor with a clickable mouse or the like and/or a keyboard. The particular user interface 600 shown in FIG. 6 is the interface home screen 605 and is presented to an individual after the individual downloads the app associated with the system 100. The user interface 600 can alternatively be accessed by an internet browser directed to the system 100 IP address. The user interface 600 may prominently display the name 610 of the polling company or any other name or may be left empty. The arrangement of the items and features shown in FIG. 6 may be rearranged, omitted, or added to as desired. The arrangement shown in FIG. 6 is merely exemplary.

As can be seen in FIG. 6, near the top of the page is a profile picture 615 for the user 105. When the user 105 first sets up his or her account, the user 105 can upload or take a picture of themselves for use as their profile picture 615. By tapping or clicking on the profile picture 615 the user 105 can be redirected to a profile page where the user 105 can input and/or edit their profile information, including demographic information, preferences, and the like. From the profile page, return to the user interface home screen 605 by tapping or clicking on the back button or by tapping or clicking on a link to the user interface home screen 605. Also near the top of the user interface home screen 605 is a settings button 620 which allows the user to set or change certain settings. An interest filter button 625 allows a user to select topics of interest, as discussed above.

A user 105 can access and/or create polls using the user interface home screen 605. For example, the user 105 can type one or more key words into a search bar 630. After entering the search terms, the user 105 will be directed to a screen displaying polls related to the key words. The order of listing of the polls can be by relevance to the key words, by poll ranking as discussed above, or in any other order. Alternatively, the user can attempt to create a new poll by typing a question into the poll question box 635. The question will be sent to the polling server 110 and the question will be analyzed for appropriateness and uniqueness as discussed in connection with FIG. 2. If unique, the user 105 will be directed to a screen where the user 105 can complete the poll question and upload it into the system. If not unique, the user 105 will be directed to the similar poll already in the system.

The user interface home screen 605 can also include additional features and displayed items. For example, as shown in FIG. 6, a feature poll block 640 may be displayed to the user 105. The feature poll block 640 may display a feature poll that is selected by the polling server based on predetermined criteria. The user 105 can select an answer to the poll question by tapping or clicking the answer or by typing a corresponding number, and then the user 105 will be directed to a results screen or the results screen will immediately appear in the feature poll block 640. Also within the feature poll block 640 is a debate section link 645. In the version of FIG. 6, the debate section link 645 is labeled “BG” to indicate battleground. A share button 650 can also be provided so that the user 105 can share the poll with his or her friends or with selected friends. The feature poll block 640 may also be provided with one or more swipe buttons, such as swipe left button 655 and swipe right button 660. The swipe buttons can be tapped or clicked on to change the content of the feature poll block 640. Alternately, especially in touch-screen versions, the swipe buttons may be removed and the content of the feature poll block 640 can be changed by using a finger to swipe left or swipe right. In one particular version, by performing a left swipe the feature poll block 640 content changes to “Friends News Feed” or the recorded history of the polls a friend has participated in or what the friend was otherwise doing within the system. A right swipe switches the feature poll block 640 to a Camera function. A typical camera view would be a photo depicting possible answers. The arrangement of these features may of course be altered and is a matter of design choice.

The user interface home screen 605 may also include a trending poll block 665 where one or more trending polls can be displayed. Trending polls may be ordered by a ranking system, such as the one described above. Each trending poll displayed in the trending poll block 665 may be interacted with much like the feature poll in the feature poll block 640. The user may answer the question posed in one or more of the trending polls, may enter the debate section associated with a first trending poll by tapping or clicking on the first trending poll debate section link 670, or may share the first trending poll by clicking on the first trending poll share button 675. Similarly, a second trending poll has answers, a second trending poll debate section link 680 and a second trending poll share button 685. The user may also scroll to see additional trending polls by tapping or clicking on one or more scroll bars 690 or by scrolling by sliding his or her finger up or down in a touch-screen version.

Although the present invention has been described in considerable detail with regard to certain preferred versions thereof, other versions are possible, and alterations, permutations and equivalents of the version shown will become apparent to those skilled in the art upon a reading of the specification and study of the drawings. For example, the cooperating components may be reversed or provided in additional or fewer number. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

What is claimed is:

1. A system for online polling, the system comprising:
a polling server interactively connectable with a user over the internet and capable of conducting an online poll by presenting to the user a question and selectable answers, wherein in response to an answer being selected, the user is directed to a results page whereby the user can view the resulting poll data, and
wherein the polling server also allows the user to create a poll by:
receiving a question from the user;
searching the polling server for an existing poll with a similar question; and
creating a new poll if no similar poll exists.

2. A system according to claim 1 wherein if the polling server finds an existing poll with a similar question, a notice is sent to the user.

3. A system according to claim 1 wherein if the polling server finds an existing poll with a similar question, the user is directed to the existing poll.

4. A system according to claim 1 wherein the user can interact with the results of the poll by selecting one or more filters.

5. A system according to claim 4 wherein at least one of the filters relates to demographic information about poll participants.

6. A system according to claim 1 wherein the user may enter a participant interaction section associated with the poll wherein the user may post information concerning the poll and view information posted by other poll participants.

7. A system according to claim 1 wherein a plurality of polls are accessible on the polling server and wherein the user can search for a poll by sending one or more keywords to the polling server.

8. A system according to claim 1 wherein a plurality of polls are accessible on the polling server and wherein at least one poll is presented to the user in response to the user's selection of one or more topics of interest.

9. A system according to claim 1 wherein the user may select an audience to whom the new poll may be broadcast.

10. A system according to claim 1 wherein a plurality of polls are accessible on the polling server and wherein the polling server ranks each of the polls.

11. A system for online polling, the system comprising:
a polling server interactively connectable with a user over the internet and capable of conducting an online poll by presenting to the user a question and selectable answers, wherein in response to an answer being selected, the user is directed to a results page whereby the user can view the resulting poll data, and
wherein the polling server also allows the user to enter a participant interaction section related to the poll where the user may post information concerning the poll and view information posted by other poll participants.

12. A system according to claim 11 wherein the polling server associates an identifier with each selectable answer and wherein each post is marked with the identifier.

13. A system according to claim 11 wherein the user can create a new poll if and only if a similar poll is not already accessible on the polling server.

14. A system for online polling, the system comprising:
a polling server interactively connectable with a user over the internet and capable of conducting an online poll by presenting to the user a question and selectable answers, wherein in response to an answer being selected, the user is directed to a results page whereby the user can interact with the resulting poll data, and
wherein the polling server also associates the selected answer with the user's demographic information and wherein the user is able to interact with the resulting poll data by filtering the results of the poll by selecting one or more items of demographic information.

15. A system according to claim 14 wherein the user is able to filter the resulting poll data by one or more of age, sex, gender, sexual orientation, income, race, ethnicity, marital status, dependents, residency, and geographical location.

16. A method of conducting a plurality of online polls on a server, the method comprising:
establishing an interactive connection with a user;
allowing the user to access one of a plurality of polls stored on the server, each poll including a question and selectable answers;
after the user has selected an answer, displaying to the user results of the poll including answers made by prior users; and
allowing the user to create a new poll by:
receiving a question from the user;
searching the plurality of polls for an existing poll with a similar question; and
creating a new poll if no similar poll exists.

17. A method according to claim 16 wherein if the polling server finds an existing poll with a similar question, a notice is sent to the user.

18. A method according to claim 16 wherein if the polling server finds an existing poll with a similar question, the user is directed to the existing poll.

19. A method according to claim 16 wherein the user can interact with the results of the poll by selecting one or more filters related to demographic information about the poll participants.

20. A method according to claim 16 further comprising allowing the user to enter a participant interaction section associated with the poll wherein the user may post information concerning the poll and view information posted by other poll participants.
